(19) United States
(12) Patent Application Publication
(10) Pub. No.: US 2019/0226745 A1
(43) Pub. Date: Jul. 25, 2019

(54) Liquid Nitrogen-Based Cooling System

(71) Applicant: The Tisdale Group, Lebanon, TN (US)

(72) Inventor: Donald Wade BARKER, Lebanon, TN (US)

(73) Assignee: The Tisdale Group

(21) Appl. No.: 16/253,553

(22) Filed: Jan. 22, 2019

Related U.S. Application Data
(60) Provisional application No. 62/620,664, filed on Jan. 23, 2018.

(51) Int. Cl. F25D 3/10; F25J 3/04; F25B 9/14

(52) U.S. Cl. CPC F25D 3/10; F25J 3/04412; F17C 2223/0161; F25J 2210/42; F25J 2270/904; F25B 9/14

(57) ABSTRACT

A liquid nitrogen-based cooling system features a cooling circuit and a liquid nitrogen-based heat sink. Heat absorbed by fluid flowing in the cooling circuit is subsequently absorbed by liquid nitrogen within the heat sink, which causes the liquid nitrogen to vaporize. The vaporized nitrogen is condensed back to liquid form, e.g., by means of a helium-based cryo-refrigeration system. The heat-sink includes at least a first vessel that contains the liquid nitrogen, with the cooling circuit including a series of coils passing around the first vessel in heat-exchanging contact with an exterior surface thereof so that heat can be transferred into the liquid nitrogen. The first vessel and coils may be contained within a second, outer vessel that minimizes heat transfer from the ambient environment to the fluid flowing in the cooling circuit and the liquid nitrogen within the first vessel.

### CROSS-REFERENCE TO RELATED APPLICATIONS

This application is based on and claims the priority benefit of U.S. provisional application No. 62/620,664 filed Jan. 23, 2018, the contents of which are incorporated herein by reference.

### FIELD OF THE INVENTION

In general, embodiments of the invention disclosed herein relate to cooling systems.

### DESCRIPTION OF RELATED ART

In conventional cooling systems, a refrigerant circulates throughout the system. A cold mixture of liquid and gaseous refrigerant passes through an evaporator (i.e., a heat-exchanger), where the refrigerant absorbs heat from a device or region that is to be cooled as the liquid portion of the refrigerant vaporizes. The vapor-phase refrigerant is then compressed to a higher pressure, which raises its temperature, and is subsequently condensed back to the liquid phase by cooling it with air or water flowing across the refrigerant conduit, which removes from the system heat that has been removed from the device or region that has been cooled. The liquid-phase refrigerant then passes through an expansion valve, which allows part of the refrigerant to flash-evaporate, thereby lowering its temperature before it passes back to the evaporator to continue the cycle.

Although this cooling cycle is well-established technology, it has certain limitations. For instance, in applications where significant amounts of cooling capacity are required, the cooling cycle may not provide sufficient cooling without a great deal of bulky equipment and/or without requiring large amounts of electrical power—and hence money—to run the system.

### SUMMARY OF THE INVENTION

A liquid nitrogen-based cooling system features a cooling circuit and a liquid nitrogen-based heat sink. Heat absorbed by a heat-absorbing medium circulating in the cooling circuit is subsequently absorbed by liquid nitrogen within the heat sink, which causes the liquid nitrogen to vaporize. The vaporized nitrogen is condensed back to liquid form, e.g., by means of a helium-based cryo-refrigeration system. The heat-sink includes at least a first vessel that contains the liquid nitrogen, with the cooling circuit including a series of coils passing around the first vessel in heat-exchanging contact with an exterior surface thereof so that heat can be transferred into the liquid nitrogen. The first vessel and the coils may be contained within a second, outer vessel that minimizes heat transfer from the ambient environment to the heat-absorbing medium flowing in the cooling circuit and the liquid nitrogen within the first vessel.

In a first aspect, the invention features a liquid nitrogen-based cooling system. The cooling system includes a heat sink containing a first heat-absorbing medium, i.e., a supply of liquid nitrogen, and a cooling circuit through which circulates a second heat-absorbing medium. The cooling circuit is arranged to absorb heat from a device or region to be cooled and is in heat-exchanging relationship with the heat sink. A refrigeration subsystem is arranged relative to the heat sink to condense vaporized nitrogen back into liquid nitrogen and return the condensed liquid nitrogen to the supply of liquid nitrogen. Suitably, the heat sink includes a first vessel containing the liquid nitrogen and a plurality of coils arranged in heat-transferring relationship with the liquid nitrogen, which coils form a portion of the cooling circuit through which the second heat-absorbing medium circulates.

In specific embodiments of the cooling system, the plurality of coils may pass around an exterior surface of the first vessel. Additionally, the first vessel and the coils may be disposed within a second, outer vessel, with at least a partial vacuum formed between the first and second vessels and at least a portion of the coils being disposed within the vacuum to inhibit unwanted heat transfer. The second heat-absorbing medium that circulates within the cooling system may include propylene glycol, with one or more anticorrosive agents.

In another aspect, the invention features a method for cooling a device or region of space requiring cooling. The method includes circulating a heat-absorbing medium within a cooling circuit and causing or allowing heat to be transferred to the heat-absorbing medium that is circulating within the cooling circuit. That heat is transported, via the heat-absorbing medium, to a heat sink containing a supply of liquid nitrogen, where the heat is subsequently transferred to the liquid nitrogen contained within the heat sink. This causes at least a portion of the liquid nitrogen to vaporize. Heat is then removed from the vaporized liquid nitrogen (and the overall system) to thereby cause the vaporized liquid nitrogen to condense back to liquid form, and the re-condensed liquid nitrogen is returned to the supply of liquid nitrogen contained within the heat sink.

We have found that cooling with systems and methods in accordance with the invention offers significant increases in efficiency and cost savings.

### BRIEF DESCRIPTION OF THE DRAWINGS

These and other features of the invention will become clearer in view of the description below and the accompanying figures, in which:

FIG. 1 is a schematic view illustrating an embodiment of a cooling system in accordance with the invention;

FIG. 2 is an elevation view of the primary heat sink used in the cooling system illustrated in FIG. 1;

FIG. 3 is a section view taken along the lines 3-3 in FIG. 2;

FIG. 4 is a top view of the primary heat sink used in the cooling system illustrated in FIG. 1;

FIG. 5 is a partial section view taken along the lines 5-5 in FIG. 4;

FIG. 6 is a perspective view of the primary heat sink shown in FIGS. 1 and 2;

FIG. 7 is a perspective view illustrating cooling calls that are present within the primary heat sink shown in FIGS. 1, 2, and 6; and

FIG. 8 is a partial, bottom perspective view illustrating the cooling coils shown in FIG. 7.

### DETAILED DESCRIPTION OF EMBODIMENTS

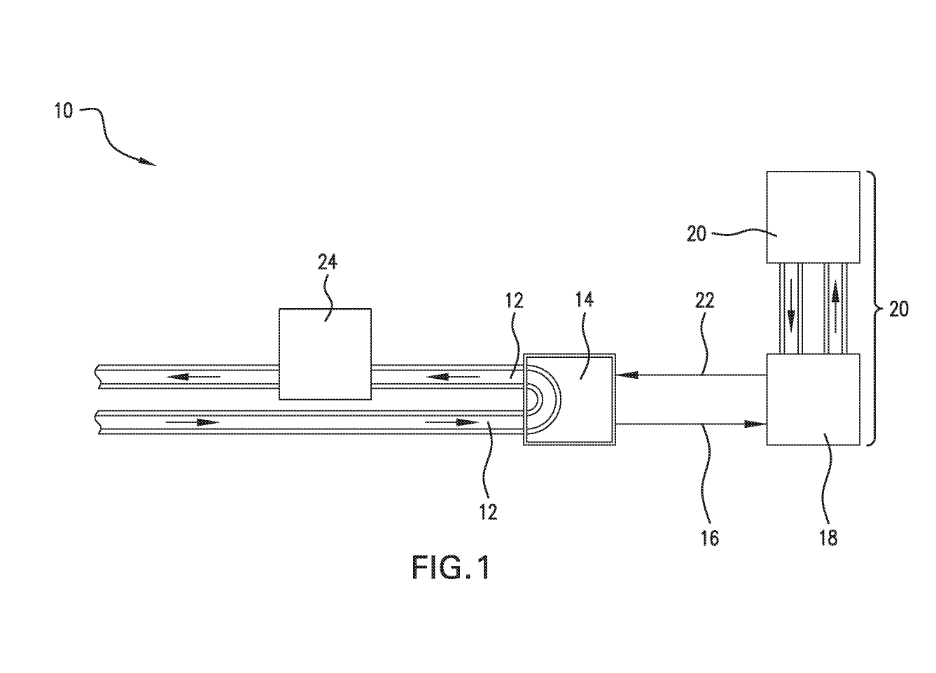

An embodiment of a cooling system 10 in accordance with the invention is illustrated in the figures. As illustrated in FIG. 1, such a cooling system 10 has a cooling circuit 12 through which heat-absorbing fluid flows and a liquid nitrogen-based heat sink 14. The heat-absorbing fluid circulating within the cooling circuit 12 absorbs heat from a device (e.g., a server rack or the moisture-condensing surface of an atmospheric water harvester) or area (e.g., a room or refrigerated cargo vehicle) that is to be cooled by means of a suitable heat-exchanger (not illustrated), and that absorbed heat is then transferred to liquid nitrogen contained within the heat sink 14. As the liquid nitrogen absorbs heat, it partially vaporizes into a headspace within the heat sink 14, as indicated schematically by arrow 16. The vaporized nitrogen is cooled on the “cold head” portion 18 of a helium-based cryo-refrigeration system 20 (i.e., a refrigeration subsystem), e.g., as available from Cryomech, Inc., in Syracuse, New York, which causes it to condense back into liquid form as indicated schematically by arrow 22. Suitably, the heat-absorbing fluid flowing in the cooling circuit 12 is a mixture of propylene glycol and one or more anticorrosive agents, e.g., inhibited propylene glycol available from Chemworld in Roswell, Ga. (80%-100% propylene glycol with potassium hydroxide (<1%) and sodium molybdate (<1%)), and a conventional fluid-circulating pump 24 (e.g., a water pump) is provided in the cooling circuit 12 to circulate the propylene glycol fluid through the circuit 12.

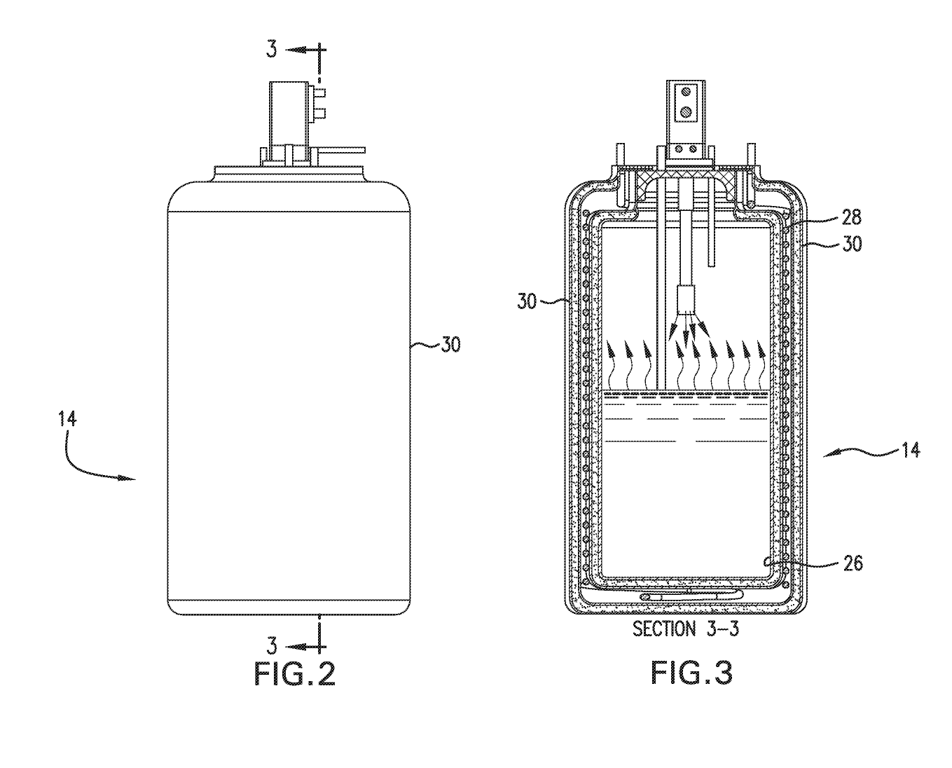

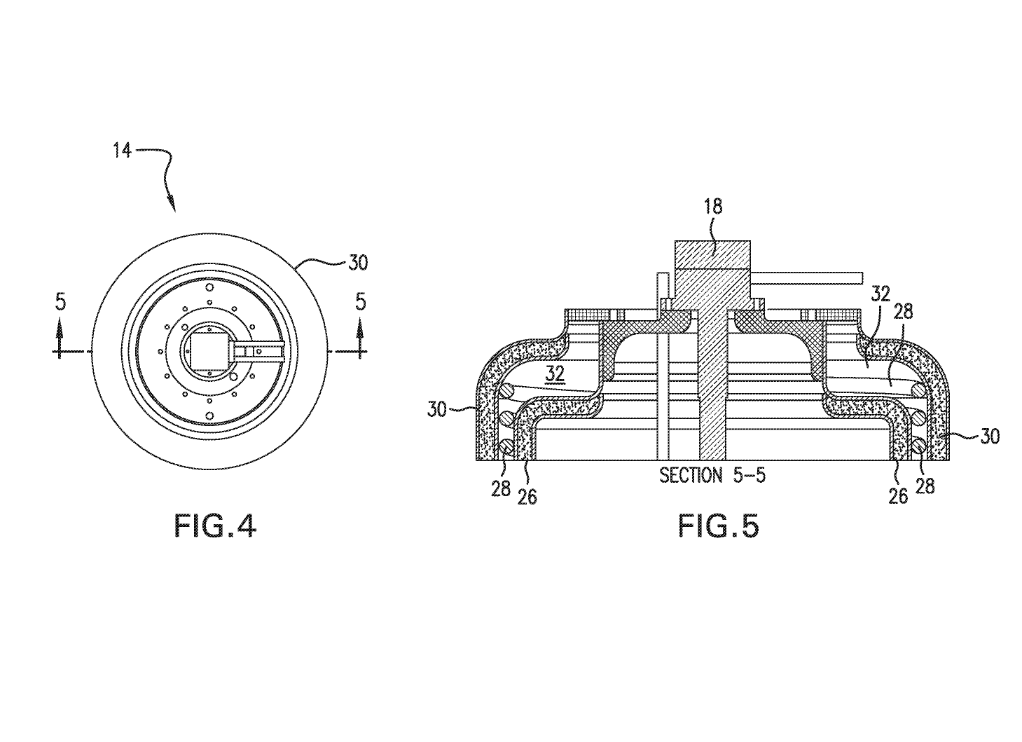

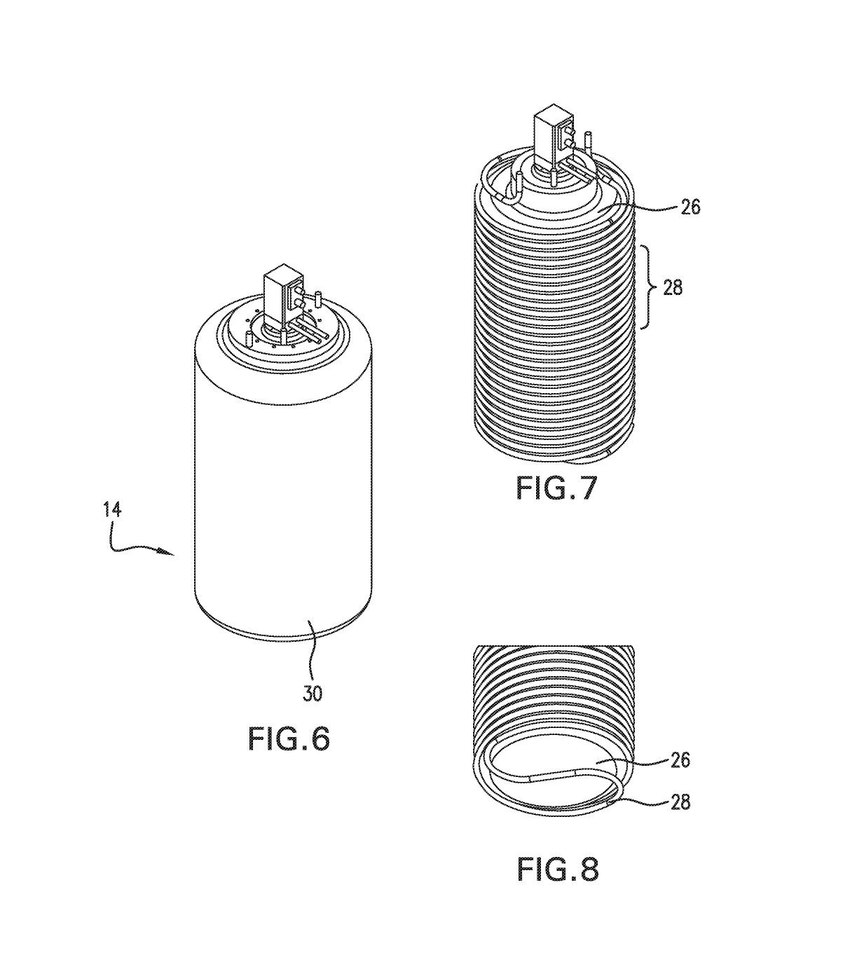

Further details of the liquid nitrogen-based heat sink 14 are illustrated in FIGS. 2-8. As best illustrated in FIGS. 3 and 7, the liquid nitrogen-based heat sink 10 includes a first vessel 26, which contains an operating supply of liquid nitrogen. Suitably, the first vessel 26 has a double-wall construction, with the space between the inner and outer walls of the first vessel 26 being filled with an insulating material such as an aerogel. The objective of including an aerogel is not to completely inhibit heat transfer across the wall structure of the first vessel 26; rather, it is to regulate heat transfer—and thereby determine performance specifications for the liquid nitrogen-based heat sink 14—by providing a known thickness of the material, since aerogels have easily quantifiable heat-transfer characteristics. Suitably, the first vessel 26 is constructed from aluminum, which has an excellent strength-to-weight ratio and suitable heat-transfer characteristics; which is extremely common; and which is therefore relatively inexpensive.

As further illustrated in FIGS. 3, 5, 7, and 8, a number of coils 28, which are part of the cooling circuit 12, are wrapped around the first vessel 26. The coils 28 are suitably tack-welded to the exterior surface of the first vessel 26 at regular intervals along the length of the coils 28 to ensure good thermal contact between the coils 28 and the first vessel 26. Thus, it will be appreciated that heat that has been absorbed by the propylene glycol within the cooling circuit 12 (from the device or area that is to be cooled) will be transferred through the walls of the coils 28 and the walls of the first vessel 26 to be absorbed by the liquid nitrogen within the vessel 26 as the propylene glycol circulates around the periphery of the first vessel 26.

As the liquid nitrogen absorbs heat, it vaporizes into the headspace within the vessel 26. As noted above, the nitrogen vapor is cooled by the cold head 18 of helium-based cryo-refrigeration system 20—the cold head 18 extends into the interior of the first vessel 26—and condenses back into liquid form, which drips back into the supply of liquid nitrogen.

Furthermore, the first vessel 26 and surrounding coils 28 are suitably contained within a second, outer vessel 30. Like the first vessel 26, the second vessel 30 also suitably has a double-wall construction, with the space between the inner and outer walls of the second vessel 30 being filled with an insulating material such as an aerogel. Additionally, at least a partial vacuum is suitably drawn in the space 32 between the first and second vessels 26, 30, i.e., the space in which the coils 28 are located. The combination of (partial) vacuum between the walls of the first and second vessels 26, 30 and insulating material such as aerogel between the inner and outer walls of the second, outer vessel 30 significantly limits—perhaps even eliminating—heat transfer into the propylene glycol in the coils 26 from the ambient atmosphere.

Based on models we have conducted, it costs significantly less to cool a large-scale system using a cooling system as described above than it costs to cool the same system using a conventional cooling system. For example, according to our calculations, a large-scale server system with 350,000 watts of computing power requires 1.2 million BTU of cooling capability. Current technology like that described in the background section above requires 352,000 watts to run a suitably sized cooling system at a cost (based on local energy rates) of almost $22,000 per month, whereas a system as per the invention only requires 2,500 watts (to drive the circulation pump 18 and the cryo-refrigeration unit 20) to run a suitably sized system at a cost on the order of $155 per month. Such savings are deemed to be highly significant.

What is claimed is:

1. A liquid nitrogen-based cooling system, comprising:
a heat sink containing a first heat-absorbing medium comprising a supply of liquid nitrogen;
a cooling circuit through which circulates a second heat-absorbing medium, the cooling circuit being arranged to absorb heat from a device or region to be cooled and being arranged in heat-exchanging relationship with the heat sink; and
a refrigeration subsystem arranged relative to the heat sink to condense vaporized nitrogen back into liquid nitrogen and return the condensed liquid nitrogen to the supply of liquid nitrogen;
wherein the heat sink comprises at least a first vessel containing the liquid nitrogen and a plurality of coils arranged in heat-transferring relationship with the liquid nitrogen, the plurality of coils forming a portion of the cooling circuit through which the second heat-absorbing medium circulates.

2. The cooling system of claim 1, wherein the plurality of coils pass around an exterior surface of the first vessel.

3. The cooling system of claim 1, wherein the first vessel and the plurality of coils are disposed within a second, outer vessel, with at least a partial vacuum between the first and second vessels and at least a portion of the coils being disposed within the at least partial vacuum.

4. The cooling system of claim 1, wherein the refrigeration subsystem comprises a helium-based cryo-refrigeration system.

5. The cooling system of claim 1, wherein the second heat-absorbing medium comprises propylene glycol.

6. The cooling system of claim 5, wherein the second heat-absorbing medium comprises a mixture of propylene glycol and one or more anticorrosive agents.

7. A method for cooling a device or region of space requiring cooling, comprising:
circulating a heat-absorbing medium within a cooling circuit;
causing or allowing heat to be transferred from the device or region of space requiring cooling to the heat-absorbing medium that is circulating within the cooling circuit;
transporting the heat, via the heat-absorbing medium, to a heat sink containing a supply of liquid nitrogen;
causing or allowing the heat being transported by the heat-absorbing medium to be transferred from the heat-absorbing medium to the liquid nitrogen contained within the heat sink to thereby cause at least a portion of the liquid nitrogen to vaporize;
removing heat from the vaporized liquid nitrogen to thereby cause the vaporized liquid nitrogen to condense back to liquid form; and
returning the nitrogen that has been condensed back to liquid form to the supply of liquid nitrogen contained within the heat sink.
